(19) United States
(12) Patent Application Publication
(10) Pub. No.: US 2014/0318463 A1
(43) Pub. Date: Oct. 30, 2014

(54) CHIP, IN PARTICULAR FOR COMING INTO CONTACT WITH AND/OR HAVING AN EFFECT ON ANIMAL FOOD OR AQUARIUM WATER

(71) Applicant: Brueggli, Romanshorn (CH)

(72) Inventor: David Fischer, Kreuzlingen (CH)

(21) Appl. No.: 14/360,394

(22) PCT Filed: Nov. 23, 2012
(86) PCT No.: PCT/EP2012/004863

§ 371 Date: May 23, 2014

(30) Foreign Application Priority Data
Nov. 25, 2011 (DE) 20 2011 108 348.2

(51) Int. Cl. A01K 63/00; A01K 61/02; A01K 7/00; A01K 5/01

(52) U.S. Cl. CPC A01K 63/006; A01K 5/01; A01K 61/025; A01K 7/00
USPC 119/61.5; 119/51.01

(57) ABSTRACT

The invention relates to a chip (1), in particular for coming into contact with and/or having an effect on animal food or aquarium water. The chip (1) comprises a fixing device (10) for fixing the chip (1) on a target object, and a receiving space (20), in which an application agent (30) is housed. The fixing device (10) comprises an adhesion or gluing surface. The application agent (30) comprises at least one of the following: at least one vitalisation agent, at least one nutritional supplement, at least one crystal, at least one mineral, in particular at least one quartz.

The invention relates to a chip. The chip is preferably provided for coming into contact with animal food and/or for effecting on animal food. Alternatively or additionally, the chip is preferably provided for coming into contact with aquarium water (e.g. for attaching to an internal surface of an aquarium) and/or for effecting on aquarium water.

Feed dishes for animals, for example, dogs, cats or other domestic animals are known in a wide variety of embodiments. Functionally, the known feed dishes are typically bowl-shaped objects which are filled with food or water which is then consumed by the animals.

It is an object of the invention to extend and/or improve the functionality of conventional feed dishes. It is a further object of the invention to provide a possibility by means of which animal food can be supplemented and/or suitably positively influenced in a simple way. However, the invention is not restricted to embodiments which solve all the aforementioned objects. Rather, the invention also claims protection in general for the embodiments described below.

The invention comprises a chip. The chip is preferably suitable for coming into contact with animal foods and/or for effecting on animal foods. Alternatively or additionally, the chip is preferably provided for coming into contact with aquarium water (e.g. for attaching to an internal surface of an aquarium) and/or for effecting on aquarium water.

In the context of the invention, “animal foods” comprise foods suitable for animals, in particular water and/or nutrition (e.g. feed), preferably for dogs, cats, fish or other animals.

The chip comprises an attaching means in order to attach the chip to a target object, and a receiving space in which an application means is accommodated.

The application means is preferably selected from the group comprising: at least one crystal, in particular at least one crystal body, at least one mineral (e.g. minerals of, for example, the same or different types), at least one quartz (e.g. a quartz body), at least one vitalisation agent (e.g. a vitalising material, a vitalising substance, etc.), at least one nutritional supplemental agent.

The vitalisation and/or nutritional supplemental agents in the context of the invention can comprise, in particular, conventional nutritional supplements, vitamins, mineral nutrients, etc., but also herbal and/or homeopathic substances or even drugs or medications. The crystal, mineral or quartz can be, for example, a so-called “healing stone”.

The receiving space can be, for example, partially or entirely filled by the application means.

The attaching means preferably comprises an adhesion or gluing face configured, for example, as adhesion or gluing film.

The chip preferably has a layered structure. The chip is preferably elastically deformable.

It is possible for the receiving space and/or the application means to be provided between a first layer and a second layer. The first layer and/or the second layer are preferably transparent. The first layer and the second layer may be, for example, one and the same layer. Preferably, however, the first layer and the second layer are different layers, for example, a polyester layer and a PVC (polyvinyl chloride) layer.

It is possible that the first layer is a film layer, in particular a PVC film layer and/or that the second layer is a film layer, in particular a polyester film layer.

It is possible that an external shell of the chip is formed by at least one external layer or comprises at least one external layer, in particular a prepolymer layer, a layer of thermoplastic plastic or a layer of another suitable plastics material.

The external layer can be, for example, multiple times thicker than the first layer and/or the second layer which preferably merely have a typical film thickness.

It is possible that the external shell directly or indirectly surrounds the first layer, the second layer and/or the application means, suitably externally, preferably on all sides or at least covers them on one side.

The external shell is preferably transparent.

The first layer and the second layer can be connected to one another in the edge regions thereof (e.g. glued, welded, etc.), preferably so that the receiving space is closed in the peripheral direction and/or so that the application means is isolated from the external shell.

The first layer and/or the second layer are preferably configured such that the application means can act externally and/or can escape.

The first layer and/or the second layer can be, for example, closed or can have one or more openings.

The attaching means is preferably provided on the external shell, in particular the prepolymer layer.

It is possible that sections of the chip coming into contact with the animal foods or the aquarium water are configured to be food-safe. In particular, it is possible that at least one of the following is configured to be food-safe: the attaching means, in particular the adhesion or gluing face, the external shell of the chip or the chip in general. Thereby, it can suitably be ensured that no health risk to animals is caused by the chip.

It is also possible that at least one of the following is configured to be waterproof and/or moisture-proof: the attaching means, in particular the adhesion or gluing face, the external shell of the chip or the chip in general. Thereby, it can preferably be ensured that the chip is also not damaged under the effect of water and/or moisture and/or remains safely attached to the target object.

The chip is configured, in particular, in order to come into direct contact with animal food and/or aquarium water.

The target object is preferably a feed dish and/or water dish for animals, in particular dogs or cats, or an aquarium for fishes.

The attaching means or the chip in general is preferably configured in order to be attached to an internal surface, in particular a bottom inner surface, of the feed dish or water dish or in order to be attached onto an internal surface of the aquarium, for example, above or below the water level. However, attaching to an external surface of the feed dish or water dish and the aquarium is also conceivable.

The application means is preferably energetically charged, for example, according to penergetic technology or similar technologies for processing and/or frequency transmission.

The chip preferably has a deformable layered structure.

The chip can have, for example, a thickness of less than or equal to 4.0 mm; 3.0 mm; 2.5 mm or 2.0 mm and/or a diameter of less than or equal to 50 mm; 45 mm; 40 mm or 33 mm.

Preferably, the external periphery of the chip is configured to be edge-free and/or at least partially curved, for example, circular or oval. The surface form of the chip is also preferably configured edge-free and/or at least partially curved. Thereby, in particular, it is made possible that an animal perceives contact with the chip (for example, during licking it with the tongue) as not unpleasant.

The invention also covers a feed dish and/or water dish for animals or a fish aquarium with a chip, in particular for coming into contact with and/or for effecting on animal food or aquarium water. The chip comprises a receiving space in which an application means is accommodated. The application means is selected, for example, from the group including: a vitalisation agent, a nutritional supplemental agent, a crystal, a mineral, a quartz. Otherwise, the chip can be configured as described herein.

It should also be mentioned that at least one of the following can also be made of polyoxymethylene (POM): the first layer, the second layer and the external layer forming the external shell.

The features and preferred exemplary embodiments of the invention as described above can be combined with one another as desired. Other advantageous developments of the invention are disclosed in the subclaims or are contained in the following description of exemplary embodiments of the invention which makes reference to the accompanying drawings, in which:

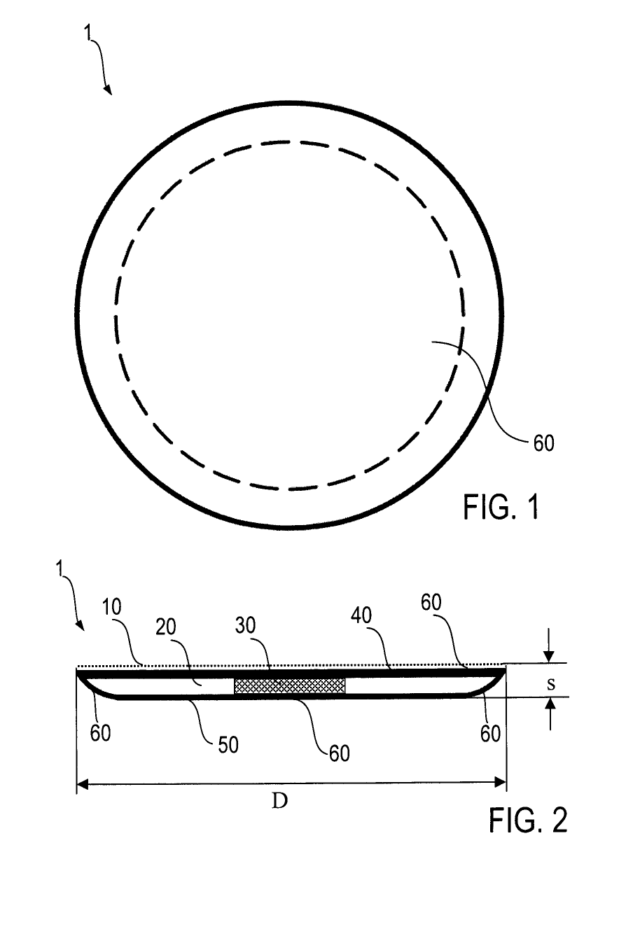

FIG. 1 shows a schematic plan view of a chip according to an embodiment of the invention,

FIG. 2 shows a schematic side view of the chip of FIG. 1, and

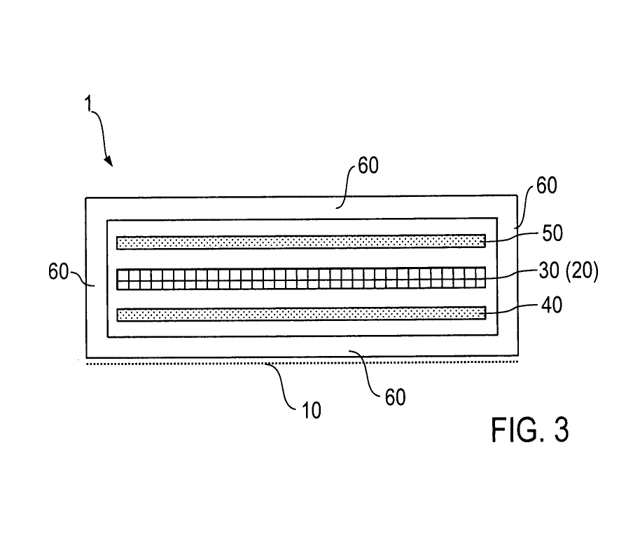

FIG. 3 shows a schematic cross-sectional view of a chip according to an embodiment of the invention.

FIG. 1 shows a plan view of a chip 1 according to an embodiment of the invention, whilst FIG. 2 shows a side view of the chip 1 of FIG. 1. The chip 1 is provided and suitable for coming into contact with and/or for having an effect on animal food, in particular feed and water.

The chip 1 comprises an attaching means 10 in order to attach the chip 1 to a target object in the form of a feed dish or water dish (e.g. for dogs or cats), preferably on the inside of the bottom thereof, so that the chip 1 comes into direct contact with animal food and can have a preferably direct effect thereon. The attaching means 10 is configured as an adhesion or gluing face.

The chip 1 further comprises a receiving space 20 in which an application means 30 is accommodated. The application means 30 can completely or partially fill the receiving space 20. The application means 30 can be, e. g, a crystal, a mineral, a quartz, a vitalisation agent, and/or a nutritional supplemental agent. The application means 30 can be, e. g., energetically charged.

The chip 1 also comprises a first layer 40 which is configured as a PVC film layer. The chip 1 also comprises a second layer 50 which is configured as a polyester film layer. The receiving space 20 and the application means 30 are arranged between the first layer 40 and the second layer 50.

In particular, the second layer 50 is configured such that the application means 30 can act or escape outwardly. The second layer 50 can be configured free of openings or with one or more openings.

The external shell of the chip 1 is made up of at least one prepolymer layer 60 which externally surrounds the first layer 40, the second layer 50 and the application means 30 directly or indirectly on all sides.

The surface form of the chip 1 and the outer periphery of the chip 1 are edge-free and are configured at least partially curved, so that they are not perceived as unpleasant when they are touched by an animal.

The attaching means 10 in the form of the adhesion or gluing face and the external shell of the chip 1 formed by the external layer 60 or portions of the chip 1 in general which come into contact with animal food are configured to be food-safe and water or moisture-resistant. It is thereby ensured, firstly, that no hazard to the health of animals arises from the chip 1 and, secondly, that the chip 1 is not damaged even under the action of water or moisture and remains securely attached to the target object.

The chip 1 preferably has a thickness s of approximately 1.9 mm and a diameter D of approximately 33 mm. The support substrate 40 preferably has a thickness of approximately 0.3 mm.

The external periphery of the chip 1 is circular, although it can also be, for example, oval.

It should also be mentioned that the target object does not necessarily have to be a feed dish or water dish for animals. The target object can be, for example, an aquarium for fishes. The chip 1 is preferably attached to an internal surface of the aquarium in aquarium water, above or below the water level.

FIG. 3 shows, in schematic form, a cross-sectional view of a chip according to an embodiment of the invention. The embodiment described with reference to FIG. 3 partially matches the embodiment described above, wherein similar or identical parts are identified with the same reference signs and for their description, reference is also made, for the avoidance of repetition, to the description above.

The chip 1 has a layered structure which comprises the first layer 40, the second layer 50 and the external shell formed by the prepolymer layer 60. The attaching means 10 is externally applied to the external shell. The external shell externally surrounds the application means 30, the first layer 40 and the second layer 50—directly or indirectly—on all sides.

In the schematic representation of FIG. 3, the first layer 40 and the second layer 50 are shown not connected to one another, but can be connected to one another, for example, in the edge regions thereof, for example, in order to isolate the receiving space 20 and the application means 30 from the external shell.

The invention is not restricted to the preferred exemplary embodiments described above. Rather a plurality of variants or derivations is possible which also make use of the inventive concept and therefore fall within the scope of protection. Furthermore, the invention also claims protection for the subject matter and the features of the subclaims separately from the claims to which they refer.

1. Chip for coming into contact with and/or for effecting an animal food or aquarium water, comprising:
an attaching means in order to attach the chip to a target object, and
a receiving space in which an application means is accommodated, and the application means comprises at least one of the following:
at least one vitalisation agent,
at least one nutritional supplemental agent,
at least one crystal, and
at least one mineral,
wherein the attaching means comprises an adhesion or gluing face.

2. Chip according to claim 1, wherein the application means is arranged between a transparent first layer and a transparent second layer.

3. Chip according to claim 2, wherein
an external shell of the chip is formed by at least one external layer or comprises at least one external layer, which comprises at least one prepolymer, and/or
the external shell externally surrounds the first layer, the second layer and/or the application means, directly or indirectly, on all sides, or at least one on one side.

4. Chip according to claim 3, wherein the attaching means is provided on the external shell.

5. Chip according to claim 2, wherein at least one of the first layer and the second layer is configured such that the application means can act or escape outwardly.

6. Chip according to claim 2, wherein at least one of the first layer and the second layer is configured without openings or has one or more openings.

7. Chip according to claim 2, wherein the first layer is a PVC film layer, and the second layer is a polyester film layer.

8. Chip according to claim 2, wherein the first layer and the second layer are connected to one another in edge regions thereof, so that the receiving space is closed in a peripheral direction and so that the application means is isolated from the external shell.

9. Chip according to claim 1, wherein sections of the chip coming into contact with animal food, aquarium water and/or animals are configured food-safe, wherein at least one of the following is configured to be food-safe:
the attaching means,
the application means, and
the external shell of the chip.

10. Chip according to claim 1, wherein at at least one of the following is configured waterproof or moisture-proof:
the attaching means,
the application means, and
the external shell of the chip.

11. Chip according to claim 1, wherein the chip is configured in order to come into contact directly with animal food or to come into contact directly with water of an aquarium.

12. Chip according to claim 1, wherein the target object is at least one of the following:
a feed or water dish for animals, and
an aquarium for fishes.

13. Chip according to claim 12, wherein the attaching means is configured in order to be attached to an internal surface of the feed or water dish, or in order to be attached to an internal surface of the aquarium.

14. Chip according to claim 1, wherein the application means is energetically charged.

15. Chip according to claim 1, wherein the chip has an elastically deformable layered structure.

16. Chip according to claim 1, wherein the chip has a thickness less than or equal to 4.0 mm and/or a diameter (D) less than or equal to 50 mm.

17. Chip according to claim 1, wherein a surface form of the chip is edge-free and/or is at least partially configured curved.

18. Chip according to claim 1, wherein an external periphery of the chip is edge-free and/or is at least partially configured curved.

19. Feed or water dish for animals or a fish aquarium comprising a chip for coming into contact with and/or for effecting an animal food or aquarium water, wherein the chip comprises:
a receiving space in which an application means is accommodated, and the application means comprises at least one of the following:
at least one vitalisation agent,
at least one nutritional supplemental agent,
at least one crystal, and
at least one mineral.

20. Feed or water dish for animals or a fish aquarium according to claim 19, wherein the chip has an attaching means of which the chip can be attached to the feed or water dish for animals or to the fish aquarium.

21. Feed or water dish for animals or a fish aquarium comprising a chip according to claim 1, wherein the chip is adapted to contact and/or effect animal food or aquarium water.
